(19) United States
(12) Patent Application Publication
(10) Pub. No.: US 2025/0342412 A1
(43) Pub. Date: Nov. 6, 2025

(54) USE OF RFID TECHNOLOGY, IOT AND DIGITAL TWIN TO TRACK PRODUCTION, PRODUCTIVITY, SAFETY AND QUALITY METRICS ON LARGE SOLAR PROJECTS

(71) Applicant: Terabase Energy, Inc., Berkeley, CA (US)

(72) Inventors: Matthew Paul Campbell, Berkeley, CA (US); Allan Daly, Albany, CA (US); Pierre Michel Daniel Gousseland, Frederiksberg (DK); Peter Thomas May-Ostendorp, Durango, CO (US); Davin Greene Smith, Friday Harbor, WA (US)

(73) Assignee: Terabase Energy, Inc., Berkeley, CA (US)

(21) Appl. No.: 18/655,978

(22) Filed: May 6, 2024

(51) Int. Cl. G06Q 10/0631; G06Q 50/08

(52) U.S. Cl. CPC G06Q 10/0631; G06Q 50/08

(57) ABSTRACT

Given the remote location, large surface areas, and repetitive nature of assembling and installation works for a typical large solar project, it is vital to track production, productivity, logistics, safety, and quality to meet requirement of project cost, progress, safety, etc. The invention enables passive, real-time, objective, and accurate data feed from the field to the project supervision team (foremen, superintendents, construction managers, project managers) in a combined hardware and software product. The present disclosure describes system and method embodiments that utilize algorithms, artificial intelligence, and machine learning to translate data feed into actionable insights delivered through a hybrid edge and centralized platform. This enables appropriate actions for solar project supervision and management in a timely manner, which results in increased production rates, increased productivity, a safer work environment and a higher quality project.

### TECHNICAL FIELD

The present disclosure relates generally to solar power plant installation. More particularly, the present disclosure relates to systems and methods of using various components comprising RFID technology, Internet of things (IoT) and digital twin to track and manage production, productivity, safety and quality on large solar projects.

### BACKGROUND

The importance of solar power systems is well understood by one of skill in the art. Government agencies and companies are scaling the size and number of solar solutions within their energy infrastructure. This transition from traditional fossil fuel energy systems to solar energy solutions presents several challenges. One challenge is cost-effective management of the construction process and the ability to improve on-site installation efficiency, quality, and safety during the construction process, which involves civil/road/earthwork, foundations, racking, panel installations, electrical wirings, inverters, and substation, etc.

FIG. 1 shows a typical solar farm 105 comprising an array of installed solar structures 110. Each solar structure comprises multiple solar panels 115. A large-scale solar farm typically includes hundreds of thousands of solar panels that are located across a multi-hundred-acre terrain and that are electrically coupled to provide a source of energy. In a typical installation process, multiple solar panels are securely aligned and attached to a metal structure (purlins or torque tube) to form a row of solar panels. A solar farm may comprise one or more solar arrays, with each solar array having hundreds of rows of solar panels. A row of solar panels may be supported by supporting structures (e.g., ground piles, ground screws, ballasted foundations, etc.) with the metal structure securely fastened to supporting structures at a desired rotational angle such that the solar panels are oriented for maximum energy production efficiency.

Large-scale systems are oftentimes located in remote areas and involve complex management for materials, resources, logistics, labor, etc. It can be very challenging to effectively track production, productivity, safety, and quality on large solar projects.

What is needed are systems and methods that can effectively and automatically track and manage production, productivity, safety, and quality to facilitate large solar projects.

### BRIEF DESCRIPTION OF THE DRAWINGS

References will be made to embodiments of the invention, examples of which may be illustrated in the accompanying figures. These figures are intended to be illustrative, not limiting. Although the invention is generally described in the context of these embodiments, it should be understood that the description is not intended to limit the scope of the invention to these particular embodiments. Items in the figures may be not to scale.

FIG. 1 depicts a general layout of a large-scale solar site.

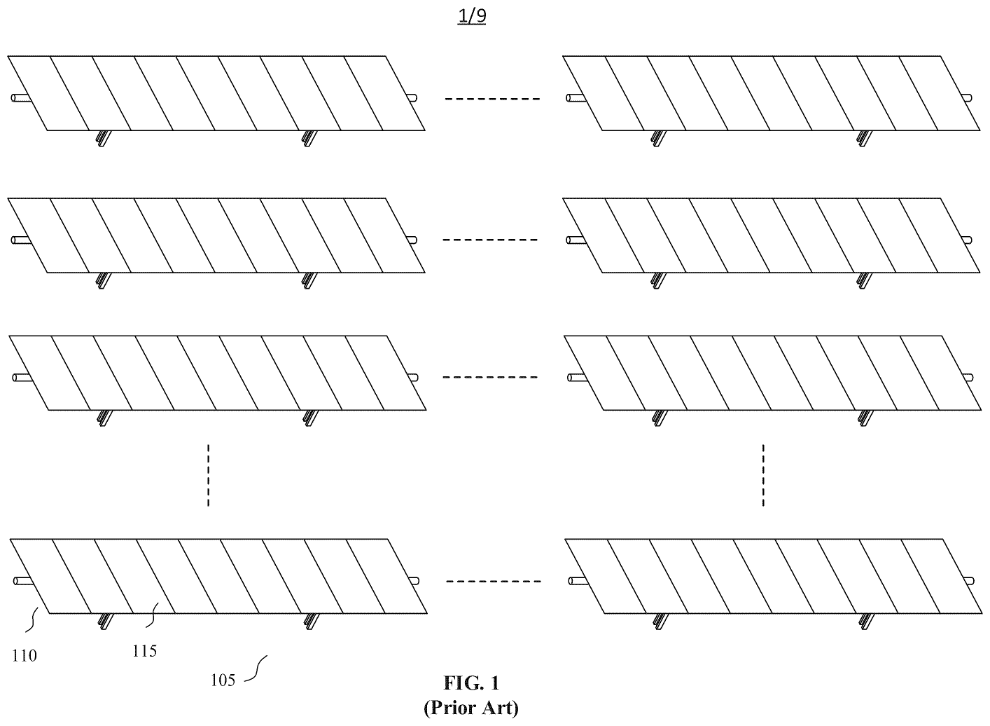

FIG. 2A depicts a distributed construction processes for solar module installation.

FIG. 2B depicts a centralized solar table assembly and installation for large-scale solar systems according to various embodiments of the invention.

FIG. 3 depicts a component layout of a solar site tracking and management system in accordance with various embodiments of the invention.

FIG. 4 depicts a layer diagram for the solar site tracking and management system in accordance with various embodiments of the invention.

FIG. 5 depicts a block diagram of an IoT device in accordance with various embodiments of the invention.

FIG. 6 depicts a block diagram of an edge data center in accordance with various embodiments of the invention.

FIG. 7 depicts a process diagram for data collection and transmission in a solar field in accordance with various embodiments of the invention.

FIG. 8 depicts a process diagram for information handling for solar site tracking and management in accordance with various embodiments of the invention.

### DETAILED DESCRIPTION OF EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, such as a process, an apparatus, a system, a device, or a method.

Components, or features, shown in diagrams are illustrative of exemplary embodiments of the invention and are meant to avoid obscuring the invention. It shall also be understood that throughout this discussion components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components in a system for tracking and managing production, productivity, safety and quality on large projects, such as a construction of large-scale solar farm.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. Also, the appearances of the above-noted phrases in various places in the specification are not necessarily all referring to the same embodiment or embodiments.

The use of certain terms in various places in the specification is for illustration and should not be construed as limiting. A component, function, or structure is not limited to a single component, function, or structure; usage of these terms may refer to a grouping of related components, functions, or structures, which may be integrated and/or discrete.

Further, it shall be noted that: (1) certain components or functionals may be optional; (2) components or functions may not be limited to the specific description set forth herein; (3) certain components or functions may be assembled/combined differently; and (4) certain functions may be performed concurrently or in sequence.

Furthermore, it shall be noted that many embodiments described herein are given in the context of the assembly and installation of large numbers of solar panels within a system, but one skilled in the art shall recognize that the teachings of the present disclosure may apply to other large and complex construction sites in which resources and personnel are difficult to manage and accurately predict. Additionally, embodiments of the present invention may be implemented in smaller solar construction sites or construction sites for applications other than solar farms.

In this document, “large-scale solar system” or “large solar projects” refers to a solar system or project involving installation and/or operation of 1000 or more solar panels. The word “resources” refers to material, parts, components, equipment or any other items used to construct a solar table and/or solar system.

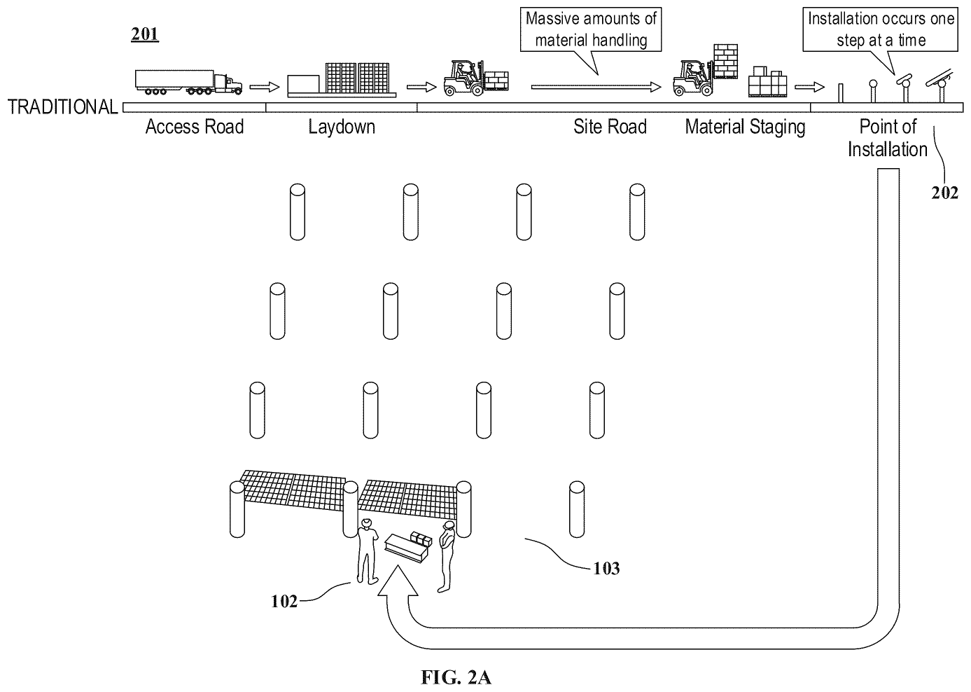

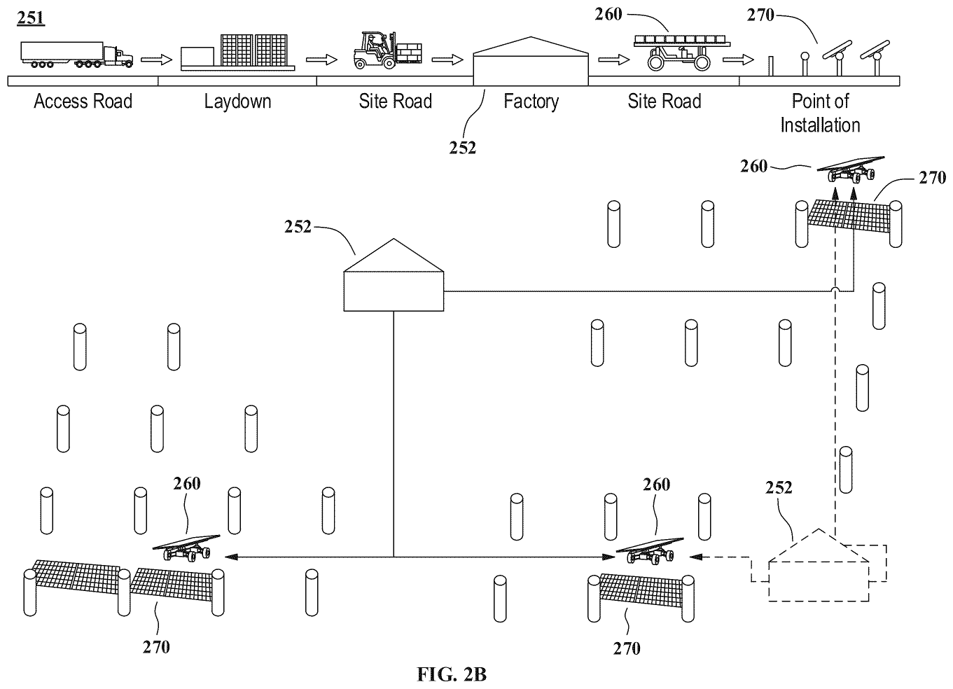

FIG. 2A depicts a distributed construction process for solar module installation. Such an installation process 201 is implemented such that all mounting equipment for each solar panel is individually assembled and installed at its location 202 within the larger system. Such traditional deployment relies on materials being delivered to a deployment site via an access road. The materials are then processed and staged at the deployment site by a crew. A small portion of this delivered material is then moved by heavy equipment to a specific location where a solar panel and mounting equipment are assembled and installed at an installation location. The step is then repeated for an adjacent installation location where materials are subsequently delivered, assembled and installed for a neighboring solar table within the system. For a large solar system, such an installation process becomes costly and has challenges of consistency and reliability of over the entire installation process.

FIG. 2B depicts a centralized solar table assembly and installation for large-scale solar systems according to various embodiments of the invention. Resources are brought to a construction site 251 for a large-scale solar system and initially processed. These resources are delivered to one or more assembly factories 252 where a coordinated and centralized solar table assembly process is performed. The term “solar table” refers to a structural assembly comprising one or more photovoltaic (PV) or solar panels and/or one or more panel frames (or purlins) for panel support. Some types of solar panels may have electrical harnesses and supplemental structure that allow them to connect to other solar panels or foundations/piles while other types do not have this supplemental structure. Assembled solar tables and equipment are moved from a factory 252 to a point of installation 270 via motorized vehicles 260. The approach of utilizing centralized and coordinated assembly factory may allow a more cost-effective and dynamic process of constructing large-scale solar systems.

Given that large surface areas for a typical large solar project and repetitive nature of assembling and installation works (for either distributed construction processes or centralized solar table assembly/installation process), it is vital to track production, productivity, logistics, safety, and quality to meet requirement of project cost, progress, safety, etc.

Traditionally, superintendents, foremen, quantity surveyors and QHSE inspectors are mobilized on site. Clipboards, radios, phones, and other conventional tools are used to collect data and progress is typically reported daily. The data collected may be incomplete and inaccurate and not contextualized. Therefore, it mostly falls short in providing actionable insights to the site team members in charge of delivering the project within expected parameters.

The invention enables passive, real-time, objective, and accurate data feed from the field to the project supervision team (foremen, superintendents, construction managers, project managers) in a combined hardware and software product. Described hereinafter are system and method embodiments of the invention that utilize algorithms, artificial intelligence, and machine learning to translate data feed into actionable insights delivered through a centralized platform. This enables appropriate actions for solar project supervision in a timely manner, which results in increased production rates, increased productivity, a safer work environment and a higher quality project. It shall be noted the embodiments of the present invention are applicable not only to solar farm projects constructed using the centralized solar table assembly and installation process, but also applicable to solar farm projects constructed using the traditional distributed construction processes.

### A. Embodiments of Centralized Platform for Project Tracking and Management

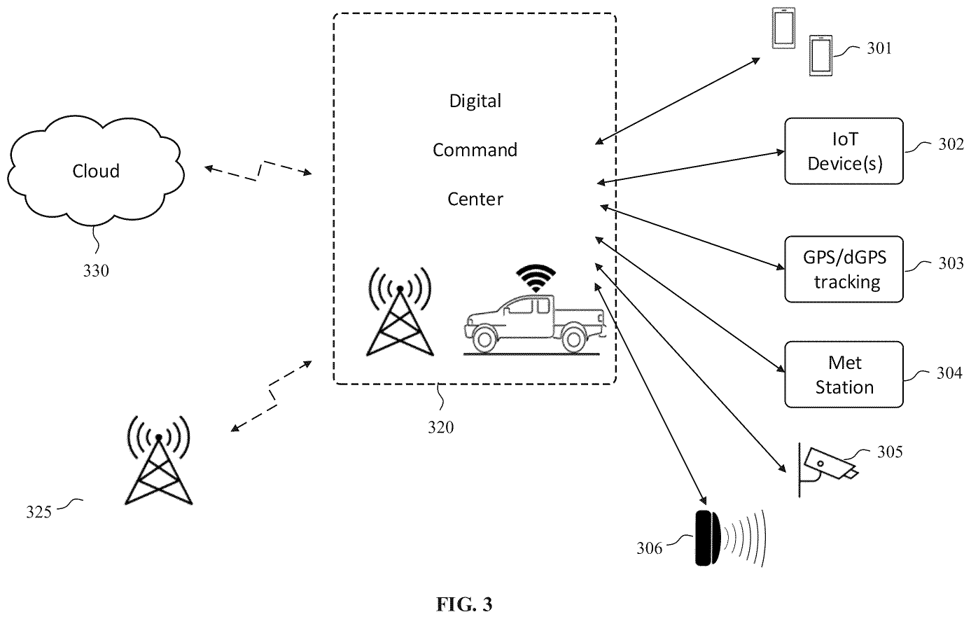

FIG. 3 depicts a component layout of a solar site tracking and management system in accordance with various embodiments of the invention. A digital command center 320 and distributed communication infrastructure 325 are deployed in a solar field to communicatively couple to a plurality of field devices or sensors, including portable electronic terminals (e.g., smartphones or tablets) 301, multiple Internet of things (IoT) devices 302, one or more global positioning system (GPS) sensors 303, a meteorological (MET) Station 304, and one or more cameras 305, one or more Radio Frequency Identification (RFID) readers 306, etc. The portable electronic terminals 301 may have a native app or mobile app installed for communications, e.g., receiving messages, reporting status, and uploading pictures/videos, etc. The IoT devices 302 are pieces of sensors or machines that may be configured for data transmission over a network. The IoT devices 302 and the GPS sensors 303 may be embedded into various other devices, such as a mobile solar table vehicle 210 for solar table delivery tracking, or a construction machinery for construction progress monitoring. The MET Station 304 may be used to collect information of weather meteorological conditions that may impact on-site installation and/or operational performance of installed solar modules. The RFID readers 306 have one or more RF antennas to emit radio waves and receive signals back from RFID tags, which may be placed on materials and personnel for information retrieval.

The digital command center 320 may serve as a centralized platform deployed on-site to collect information timely or in real-time from the plurality of field devices or sensors. In one or more embodiments, the digital command center 320 may also serve as an edge data center to perform edge computing, such as data aggregation, data compression, data encryption, etc., to enable certain data processing at greater speeds and volumes, to thus make data transmission between the edge data center and the cloud faster and safer. The edge computing is advantageous especially for processing some safety-related matters which are strongly preferred to be handled in real-time and on-site.

In one or more embodiments, the digital command center 320 may communicatively couple to a cloud 330 for cloud services, such as cloud computing and/or cloud storage. The digital command center 320 may communicate to the cloud via satellite communication, cellular communication, or other means.

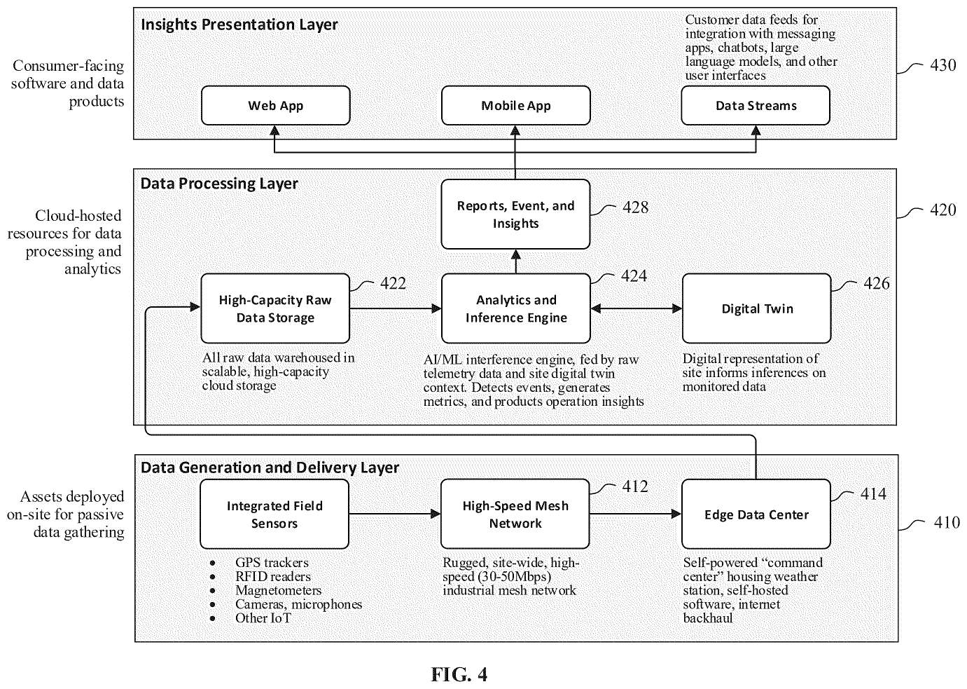

FIG. 4 depicts a layer diagram, comprising a data generation and delivery layer 410, a data processing layer 420, and an insights presentation layer 430, for the solar site tracking and management system in accordance with various embodiments of the invention. The data generation and delivery layer 410 involves data collection and receiving. Data collection is handled by field sensors, such as GPS trackers, RFID readers, accelerometers, cameras, microphones and other IoT systems, deployed throughout the solar field for passive data gathering continuously, intermittently, or in real-time. The field sensors may be mounted on construction equipment like telehandlers, skidsteers, vehicles utilized by crews, attached to materials used for solar construction (e.g., RFID tags on solar module packs), mounted on drones or Automated Guided Vehicles (AGVs), worn by individual workers, or installed at fixed locations (e.g., entrance gate of the solar field). The field sensors may be packaged into a turn-key solution that may be deployed on-site with minimal disruption to existing means and methods.

Data, such as equipment or materials location, may be collected by the sensors in real-time or in a predetermined time interval, packaged into standardized messages or formats, and relayed back to the edge data center 414 through an on-site, high-speed data local area network (LAN) 412. The on-site network 412 may be a mesh network comprising multiple nodes, e.g., bridges, switches, etc., that are connected to act as a single network. This network 412 may utilize an industrial mesh protocol that dynamically selects the optimal traffic path through the mesh, which is especially important to optimize network traffic on moving construction equipment.

The Digital Command Center or the edge data center may be a mobile self-powered unit ensuring connectivity between the site and the cloud using cell and satellite connection. It may contain a multi-node server cluster that hosts several key internal software applications that include but are not limited to:
a central message bus for receiving sensor messages via industry-standard Message Queuing Telemetry Transport (MQTT) protocol;
a central data ingestion agent that routes messages from certain MQTT topics to data storage;
a configuration management agent to specify how messages are routed by the central data ingestion agent;
a time series database for caching raw data gathered by field sensors, which is especially important to cache this data locally in case Internet access is interrupted;
a cloud replicator service that relays raw data from the edge database to a cloud database; and
one or more standard network services like a Dynamic Host Configuration Protocol (DHCP) server, Domain Name System (DNS) server, Network Time Protocol (NTP) server, etc.

The data processing layer 420 handles data processing and analytics using cloud-based resources, including a raw data storage 422, an analytics and inference engine 424, and a digital twin 426. Raw telemetry data, e.g., equipment location or RFID scan counts, are relayed from the edge data center to the raw data storage 422, which is a cloud storage providing a scalable and low-cost data storage mechanism. Raw data must be processed through custom data pipelines in the analytics and inference engine 424. The engine may utilize, among other applicable technologies, artificial intelligence/machine learning (AI/ML) algorithms, deep learning, neural networks, natural language processing, computer vision, and statistical analysis, for data processing.

In one or more embodiments, the analytics and inference engine 424 may access past and current project data and leverage the digital twin 426 to infer insights from raw data, like equipment telemetry (e.g. is a current pack likely being staged in the field or installed).

Through the data pipelines, various data processings may be performed for: 1) updating known locations of objects on the site and updating their positions in the digital twin; and 2) detecting construction domain-specific events, such as module pack staging or installation; 3) analyzing and summarizing operational patterns on site, and 4) generating insights 428 for reporting or real-time alerts. The domain-specific events may be structured and related to elements of the site's digital twin, a high-fidelity and high-resolution data model of the solar project under construction. The digital twin comprises dynamic project status information for monitoring project progress, delays and bottlenecks, etc. The digital twins may be updated or refreshed in real-time, periodically, or on-demand.

The insights presentation layer 430 uses consumer-facing software and data product to deliver, in one or more ways, the reports, event, insights generated in the data processing layer 420. For example, the insights may be delivered for user attention/response via a web app, a mobile app, and/or data streams.

The insights generated by the analytics and inference engine 424 are useful for users, including the foremen, site superintendents working in the field, project engineers, and project managers mostly working from the office. Thus, the insights presentation layer 430 utilizes various media to dispatch insights to the users in accordance with the context they operate in. Insights such as speeding events may be dispatched in real-time to foremen cell phones via messaging apps. Deeper insights generated based on larger pools of data might be provided to project engineers on a daily or weekly basis instead, allowing them to adjust project execution plans for subsequent operations. As shown in FIG. 4, insights may be presented via 1) a web app, 2) a mobile app, and 3) custom, real-time data streams that may be integrated with third-party apps like messaging apps or chatbots.

RFID tags may be placed on materials and personnel and RFID readers/scanners may be placed on various type of equipment on-site to constantly scan and capture the RFID data, GPS location, and timestamp. This data collected and streamed via the edge data center 414 through an on-premises network (e.g., mesh network 412) to on-premises computer systems for edge storage and edge processing as well as relay to the cloud. Edge computing, centralized computing, and cloud computing may be used in parallel to divide data collection and analysis tasks as appropriate to the complexity and immediacy needs of the tasks.

For example, safety tasks may be performed at the edge in such an exemplary case of a construction apparatus recognizing construction personnel in proximity to the vehicle via reading RFID tag attached to construction personals. This system can be used to increase awareness and safety in this ad hoc context. Other types of tasks such as analyzing streaming scan/location/timestamp data to determine ‘events’ may be performed at a central or cloud level.

In one or more embodiments, events and insights may be generated by evaluating/analyzing streaming data in conjunction with digital contextual data such as a digital twin of the solar power plant that captures physical, logical, and temporal (schedule) information about the construction plan and design.

### B. Embodiments of a IoT Device and an Edge Data Center

Field sensors such as GPS trackers, RFID readers, accelerometers, cameras, microphones and other IoT systems are deployed throughout the solar field. These sensors may be mounted on construction equipment such as telehandlers or vehicles utilized by crews, attached to materials used for solar construction (e.g., RFID tags on PV module packs), worn by individual workers, or installed at fixed locations.

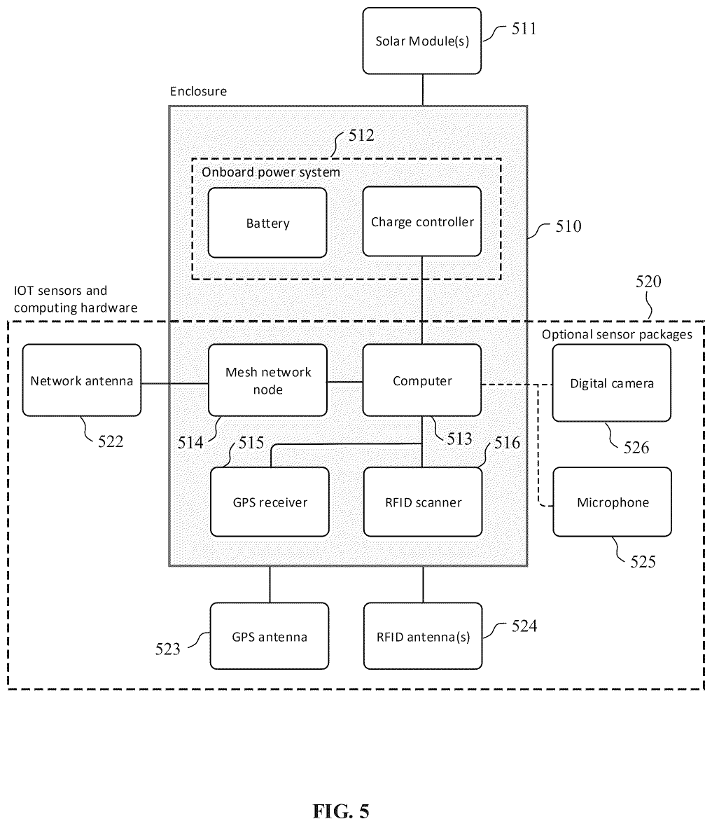

FIG. 5 depicts a block diagram of an network service module 620 in accordance with various embodiments of the invention. The IoT device 510 may be packaged within a weather-proof and tamper-resistant enclosure mounted on construction equipment. As shown in FIG. 5, the IoT device 510 is powered by one or more solar modules 511, which may be standalone modules or from the solar project. The solar module 511 provides power the IoT device 510 via an onboard power system 512 comprising a battery and a charge controller. The IoT device 510 further comprises a computer 513, a local node 514 (e.g., a mesh network node) coupled to a network antenna 522 for local network communications, a GPS receiver 515 coupled to a GPS antenna 523, an RFID scanner or reader 516 coupled to one or more RFID antennas 524. The computer 513 may also couple to other sensors, e.g., digital cameras 526 and microphone 525, for ambient safety monitoring. All the aforementioned sensors form a set of IoT sensors and computing hardware 520 deployed on-site for data collection.

It shall be noted that the IoT devices may not only be able to monitor and manage solar module installation process, but also be able to monitor infrastructure construction process. For example, IoT devices may be attached to various heavy machinery construction vehicles, e.g., excavators, loaders, bulldozers, etc., for monitoring and managing earthwork operations or other infrastructure tasks. It shall be noted that materials and activities that may be tracked and managed using the present invention encompass all items that are part of a solar power plant, bill of materials, and the installation of these items. Examples of items include but are not limited to solar panels, mounting systems, inverters, wiring and electrical components, energy storage systems, protection devices, monitoring and control systems, transformers and substation equipment, supporting structures and civil works materials, tools and maintenance equipment and other miscellaneous supplies, etc. Therefore, the embodiments of the present invention may be utilized for full-process monitoring and management for a large solar project.

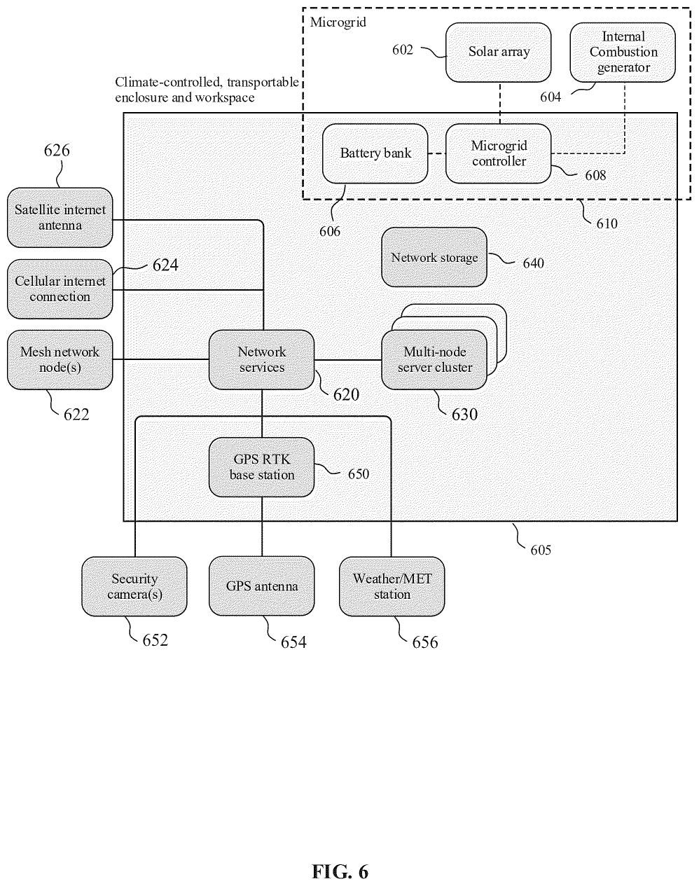

FIG. 6 depicts a block diagram of an edge data center in accordance with various embodiments of the invention. The edge data center may be deployed as a climate-controlled and transportable enclosure and workspace 605. For example, the edge data center may be packaged within a semi-trailer or even a smaller trailer which can be quickly deployed to a solar farm construction site for operation.

The edge data center may be powered by a standalone microgrid 610, which comprises a solar array 602, an internal combustion generator 604 (e.g., a diesel generator), a battery pack 606, and a microgrid controller 608 coupled to these components for grid control of battery charging, battery power output, and generator operation, etc. The solar array 602 may be an array of solar modules attached to a roof of the transportable enclosure for power generation.

The edge data center may comprise a network service module 620 that couples to one or more local network nodes 622 (e.g., mesh network nodes), cellular internet antenna 624 for cellular network connection, and satellite internet antenna 626 for satellite network connection. The edge data center may further comprise a GPS terminal or station 650, which couples to a GPS antenna 654 for receiving GPS signals for positioning of the edge data center. The network service module 620 also couples to one or more security cameras 652 to receive video images from those cameras and a MET Station 656 to receive information of weather meteorological conditions that may impact on-site construction/installation and/or operational performance of installed solar modules.

The edge data center comprises one or more server clusters 630 to perform edge computing for information received at the edge data center and a network storage 640 to store raw data received at the edge data center and edge computing results. At least part of the raw data and the edge computing results are transmitted via the network service module 620 to a cloud for cloud storage and/or cloud computing.

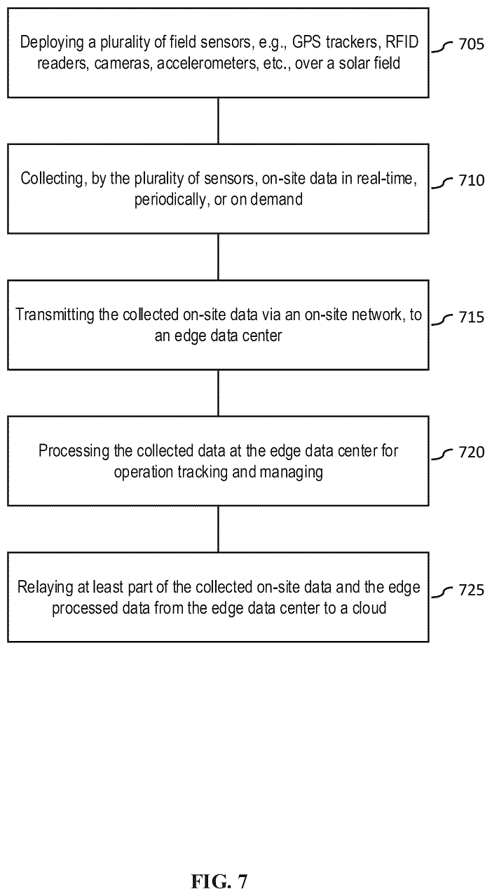

FIG. 7 depicts a process diagram for data collection and transmission in a solar field in accordance with various embodiments of the invention. In step 705, a plurality of field sensors, e.g., GPS trackers, RFID readers, cameras, accelerometers, etc., are deployed over a solar field. In step 710, on-site data is collected by the plurality of sensors data in real-time, periodically, or on demand. In step 715, the collected data on-site data is transmitted via an on-site network to an edge data center via an onsite data network. The collected data may be packaged into a standardized format, e.g., messages.

In step 720, the collected data may be pre-processed at the edge data center to generate edge processed data for operations (construction, installation, etc.) tracking and management. The data pre-processing may be related to data aggregation, compression, and/or encryption in a preparation for cloud transmission. In some embodiments, the data-preprocessing may be related to safety related matters that need or prefer to be handled on-site timely instead of waiting for cloud processing. In step 725, at least part of the collected on-site data and the edge processed data is relayed from the edge data center to a cloud for processing.

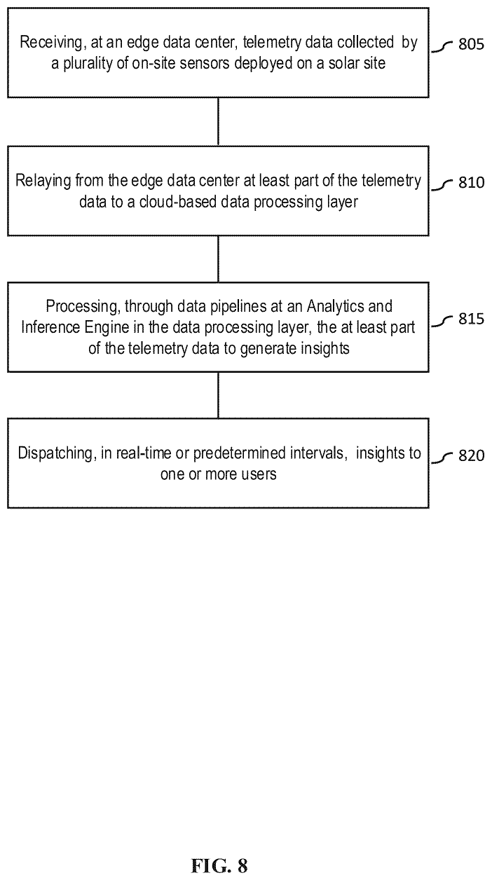

FIG. 8 depicts a process diagram for information handling for solar site tracking and management in accordance with various embodiments of the invention. In step 805, an edge data center receives telemetry data collected from a plurality of on-site sensors deployed on a solar site. In step 810, the edge data center relays at least part of the telemetry data to a cloud-based data processing layer. In step 815, the at least part of the telemetry data is processed through data pipelines at an analytics and inference engine in the data processing layer to generate reports, events and/or insights. In one or more embodiments, the analytics and inference engine may access past and current project data and leverage a digital twin to generate the insights.

In step 820, the generated insights are dispatching in real-time or predetermined intervals to one or more users. The insights may be dispatched for user attention/response via a web app, a web app, and/or data streams. The insights may be dispatched from the edge data center or from the cloud or from both. Furthermore, the insights may comprise operational patterns, alerts, and/or progresses, and may be different for different users.

Aspects of the present disclosure may be encoded upon one or more non-transitory computer-readable media with instructions for one or more processors or processing units to cause steps to be performed. It shall be noted that non-transitory computer-readable media shall include volatile and/or non-volatile memory. It shall be noted that alternative implementations are possible, including a hardware implementation or a software/hardware implementation. Hardware-implemented functions may be realized using ASIC(s), programmable arrays, digital signal processing circuitry, or the like. Accordingly, the “means” terms in any claims are intended to cover both software and hardware implementations. Similarly, the term “computer-readable medium or media” as used herein includes software and/or hardware having a program of instructions embodied thereon, or a combination thereof. With these implementation alternatives in mind, it is to be understood that the figures and accompanying description provide the functional information one skilled in the art would require to write program code (i.e., software) and/or to fabricate circuits (i.e., hardware) to perform the processing required.

It shall be noted that embodiments of the present disclosure may further relate to computer products with a non-transitory, tangible computer-readable medium that has computer code thereon for performing various computer-implemented operations. The media and computer code may be those specially designed and constructed for the purposes of the present disclosure, or they may be of the kind known or available to those having skill in the relevant arts. Examples of tangible computer-readable media include, for example: magnetic media such as hard disks, floppy disks, and magnetic tape; optical media such as CDs and holographic devices; magneto-optical media; and hardware devices that are specially configured to store or to store and execute program code, such as ASICs, PLDs, flash memory devices, other non-volatile memory devices (such as 3D XPoint-based devices), and ROM and RAM devices. Examples of computer code include machine code, such as produced by a compiler, and files containing higher level code that are executed by a computer using an interpreter. Embodiments of the present disclosure may be implemented in whole or in part as machine-executable instructions that may be in program modules that are executed by a processing device. Examples of program modules include libraries, programs, routines, objects, components, and data structures. In distributed computing environments, program modules may be physically located in settings that are local, remote, or both.

One skilled in the art will recognize no computing system or programming language is critical to the practice of the present disclosure. One skilled in the art will also recognize that a number of the elements described above may be physically and/or functionally separated into modules and/or sub-modules or combined together.

It will be appreciated to those skilled in the art that the preceding examples and embodiments are exemplary and not limiting to the scope of the present disclosure. It is intended that all permutations, enhancements, equivalents, combinations, and improvements thereto that are apparent to those skilled in the art upon a reading of the specification and a study of the drawings are included within the true spirit and scope of the present disclosure. It shall also be noted that elements of any claims may be arranged differently including having multiple dependencies, configurations, and combinations.

What is claimed is:

1. A method for tracking and managing a solar field under construction comprising:
deploying a plurality of field sensors over the solar field;
collecting, by the plurality of sensors, on-site data in real-time, periodically, or on demand;
transmitting the collected on-site data via an on-site network, to an edge data center;
processing the collected on-site data at the edge data center to generate edge processed data for operations tracking and management; and
relaying at least part of the collected on-site data and the edge processed data from the edge data center to a cloud.

2. The method of claim 1, wherein the plurality of field sensors comprise one or more of:
one or more Internet of things (IoT) devices;
one or more Radio Frequency Identification (RFID) tags that are attached to equipment, materials, or personals within the solar field;
one or more GPS sensors;
one or more cameras; and
one or more microphones.

3. The method of claim 1, wherein the on-site network is a mesh network.

4. The method of claim 1, wherein the collected on-site data is transmitted to the edge data center in a standardized format.

5. The method of claim 1, wherein the edge data center is a digital command center to perform edge computing related to safety task.

6. The method of claim 1, wherein processing the collected on-site data at the edge data center comprises data aggregation, data compression, or data encryption.

7. The method of claim 1 further comprising:
processing, through data pipelines at an analytics and inference engine in the cloud, at least part of the collected on-site data and the edge processed data to generate insights; and
dispatching, in real-time or predetermined intervals, insights to one or more users.

8. The method of claim 7, wherein the analytics and inference engine accesses past and current project data and leverages a digital twin to generate the insights.

9. The method of claim 8, wherein the digital twin is a data model of the solar field under construction, the digital twin comprises dynamic status information for the solar field.

10. The method of claim 7, wherein the insights are dispatched via a web app, a mobile app, and/or data streams.

11. A system for tracking and managing a solar field under construction comprising:
an edge data center that receives, via an on-site network, on-site data collected by a plurality of field sensors deployed over the solar field, the edge data center processes the collected data to generate edge processed data for operations tracking and management;
a cloud storage in a cloud that receives at least part of the collected on-site data and the edge processed data for data storage; and
an analytics and inference engine in the cloud, the analytics and inference engine processes at least part of the collected data and processed data to generate insights.

12. The system of claim 11, wherein the plurality of field sensors comprise one or more of:
one or more Internet of things (IoT) devices;
one or more Radio Frequency Identification (RFID) tags that are attached to equipment, materials, or personals within the solar field;
one or more GPS sensors;
one or more cameras; and
one or more microphones.

13. The system of claim 11, wherein the on-site network is a mesh network.

14. The system of claim 11, wherein the collected on-site data is transmitted to the edge data center in a standardized format.

15. The system of claim 11, wherein the edge data center is a digital command center to perform edge computing related to safety task.

16. The system of claim 11, wherein the edge data center processes the collected data for data aggregation, data compression, or data encryption to facilitate data transmission between the edge data center and the cloud.

17. The system of claim 11, wherein the analytics and inference engine dispatches, in real-time or predetermined intervals, insights to one or more users.

18. The system of claim 17, wherein the analytics and inference engine accesses past and current project data and leverages a digital twin to generate the insights.

19. The system of claim 18, wherein the digital twin is a data model of the solar field under construction, the digital twin comprises dynamic status information for the solar field.

20. The system of claim 17, wherein the insights are dispatched via a web app, a mobile app, and/or data streams.
